(19) United States
(12) Patent Application Publication
(10) Pub. No.: US 2024/0377102 A1
(43) Pub. Date: Nov. 14, 2024

(54) PROCESS AIR UNIT FOR HEATING PROCESS AIR

(71) Applicant: Dürr Systems AG, Stuttgart, Bietigheim-Bissingen (DE)

(72) Inventors: Oliver IGLAUER-ANGRIK, Stuttgart (DE); Andreas NEU, Ammerbuch (DE)

(21) Appl. No.: 18/692,173

(22) PCT Filed: Sep. 20, 2022
(86) PCT No.: PCT/DE2022/100698

§ 371 Date: Mar. 14, 2024

(30) Foreign Application Priority Data
Sep. 24, 2021 (DE) 10 2021 124 768.3

(51) Int. Cl. F24H 9/00; F24H 9/1881; F24H 15/204; F24H 15/345

(52) U.S. Cl. CPC F24H 9/0068; F24H 9/1881; F24H 15/204; F24H 15/345; F24H 2210/00

(57) ABSTRACT

A process air unit (20) for heating a process air (21) for a workpiece processing system comprises a process air duct (22) through which a process air (21) can flow, a combustion chamber (30) for burning a combustion air, which is overflowed by the process air (21) in the process air duct (22) and thereby transfers heat to the process air (21), and a tube bundle arrangement (35) connected to the combustion chamber, which comprises at least one tube bundle (36) having a plurality of tubes (38) through which the flue gas (34) from the combustion chamber (30) can flow. The plurality of tubes (38) of the at least one tube bundle (36) is oriented in the process air duct (22) transversely to the process air flow direction, so that they are overflowed by the process air (21) and thereby transfer heat from the flue gas (34) to the process air (21), and the tube bundle arrangement (35) is arranged, with respect to the process air flow direction, upstream of the combustion chamber (30) in the process air duct (22) in order to achieve increased energy efficiency.

### RELATED APPLICATIONS

This application is a national Phase of International Application No. PCT/DE2022/100698 filed on Sep. 20, 2022, and claims the benefit of German Application No. 10 2021 124 768.3 filed on Sep. 24, 2021, both of which are incorporated herein by reference in their entirety and for all purposes.

### FIELD OF DISCLOSURE

Examples disclosed herein relate to a process air unit for heating a process air, for example for a workpiece processing system.

### BACKGROUND

Warm process air flows (e.g. fresh air and/or recirculating air) often have to be introduced into process chambers of workpiece processing systems in order to carry out the corresponding workpiece processing. For example, drying painted vehicle bodies in painting processes has a high heat requirement. Generally, process air units for heating the respective process air are therefore arranged in the process air supply lines. In the process air units, the process air is usually heated indirectly by a heat transfer apparatus, i.e. not directly by burning in a combustion chamber, in order to avoid substances in the process air that are critical for workpiece processing. Conventional process air units for heating process air therefore often have a combustion chamber and a tube bundle through which the flue gas from the combustion chamber flows, which are both flowed over by the process air for the purpose of heat transfer.

### SUMMARY

Since in many workpiece processing systems are required very large quantities of process air with a high heat requirement, a lot of energy is needed to heat the process air. There is therefore a need for process air units that can heat process air in an energetically efficient manner.

This task is solved by a process air unit defined in the appended independent claim 1. Particularly advantageous embodiments and developments of examples disclosed herein are the subject of the dependent claims.

The process air unit for heating a process air, in particular for a workpiece processing system, comprises a process air duct through which a process air can flow and which comprises, in the region of a first duct end, an inlet opening for taking in a process air to be heated and, in the region of a second duct end opposite the first duct end, an outlet opening for discharging a heated process air. For heating the process air, the process air unit contains a combustion chamber for burning a combustion air, which is arranged at least partially within the process air duct so that it is overflowed by the process air and thereby transfers heat to the process air, as well as a tube bundle arrangement being connected to the combustion chamber and comprising at least one tube bundle having a plurality of tubes through which the flue gas from the combustion chamber can flow, wherein the plurality of tubes of the at least one tube bundle is oriented transversely to the process air flow direction and is arranged at least partially within the process air duct, so that they are overflowed by the process air and thereby transfer heat from the flue gas to the process air. According to examples disclosed herein, this tube bundle arrangement is arranged, with respect to the process air flow direction, upstream of the combustion chamber in the process air duct.

The inventors have found that in conventional process air units, in which the combustion chamber is first flowed over by the process air, the two main flows of flue gas and the process air run in the same direction (co-current principle) and, as a consequence, the outlet temperatures of the two material flows only assume the mixed temperature, which is energetically very inefficient. The inventors therefore propose that the process air first flows over the tube bundle arrangement, which creates a countercurrent principle in which the material flows of the process air to be heated and the flue gas run in opposite directions through the process air duct, as a result of which there is always a temperature difference between these material flows and therefore significantly more (almost all) of the heat can be transferred, whereby a significantly greater energy efficiency of the process air unit for heating the process air can be achieved. Due to the greater energy efficiency, it is also possible to simplify the geometry of the combustion chamber compared to conventional process air units (e. g. round instead of pear-shaped).

The process air unit according to examples disclosed herein can basically be used for any applications/systems. A particularly advantageous application is the heating of process air for workpiece processing systems where there is a high heat requirement, such as for drying/linking/hardening of painted and/or coated and/or glued workpieces such as car bodies or body parts, for example in the form of continuous dryers, continuous hardening systems, chamber dryers or chamber hardening systems.

In connection with examples disclosed herein defined in the independent claim 1, the following explanations of terms should be taken into account. The process air is, for example, fresh air or recirculated air or a mixture of fresh air and recirculated air, but can in principle be in any way, depending on the application. The term flue gas refers to the air burned in the combustion chamber that flows out of the combustion chamber. The process air duct can in principle be structured and dimensioned in any way, preferably is essentially in a straight line at least in the area of the combustion chamber and the tube bundle arrangement, can, in the inlet area and/or in the outlet area, depending on the application, be essentially in a straight line or, if necessary, once or multiple curved, for example has a circular or rectangular cross-sectional shape, and can have an essentially constant or variable diameter size along its length. The flows of the process air through the tube bundle arrangement and over the combustion chamber preferably run essentially in one plane, preferably essentially horizontally to the bottom side of the process air duct. The combustion chamber preferably has a simple round tubular shape. The combustion chamber and the tube bundle arrangement connected to it form a compact unit that can be inserted into the process air unit as a component. The combustion chamber and the at least one tube bundle of the tube bundle arrangement can each be arranged completely or almost completely within the process air duct, only the supply lines for fuel and combustion air and the flue gas discharge line are preferably arranged completely outside the duct. The tubes of the at least one tube bundle are aligned transversely, i.e. not parallel, but at an angle to the process air flow direction, being preferably but not necessarily essentially perpendicular to the process air flow direction. The structures and dimensions of the at least one tube bundle and its tubes are basically arbitrary, wherein the tubes, for example, can be aligned essentially parallel to one another, and wherein the tubes of several tube rows in the tube bundle can be arranged offset to or aligned with one another. The combustion chamber is generally equipped with a burner which comprises a combustible supply (e.g. natural gas, hydrogen, mixture of natural gas and hydrogen, biogas, etc.) and a combustion air supply (e.g. ambient air or an exhaust gas recirculation) and optionally an igniter and/or a heating device (e.g. an electrical or electromagnetic heating apparatus or a switchable high-temperature heat source of another type for supplying the combustion chamber with thermal energy).

In one embodiment of examples disclosed herein, the tube bundle arrangement comprises a plurality of (i.e. at least two) tube bundles which are arranged one behind the other in the process air duct with respect to the process air flow direction (and all upstream of the combustion chamber), the flue gas passing through the different tube bundles one after the other in a sequence counter to the process air flow direction and thereby flowing through the tubes of the successively arranged tube bundles in opposite directions, each transverse to the process air flow direction. By using several tube bundles in this way, the advantageous counterflow principle is used even more intensively, as the flue gas is guided through the tubes in serpentine lines in the opposite direction to the process air. In this embodiment, the plurality of tube bundles of the tube bundle arrangement preferably each comprise a plurality of tube rows which extend one behind the other with respect to the process air flow direction, in each case in comparison between two adjacent ones of the plurality of the tube bundles, the tube bundle closer to the combustion chamber preferably having a larger number of tube rows than the tube bundle further away from the combustion chamber. This measure allows optimum flow through the tubes to be achieved and the pressure loss to be kept as low as possible. The reduction in the number of tube rows between two adjacent tube bundles in the direction away from the combustion chamber preferably each is 20% to 50%, optionally approximately 30% to 40%. Since the combustion air supply for introducing combustion air into the combustion chamber and the flue gas discharge line for discharging the flue gas after flowing through the tube bundle arrangement are preferably arranged on the same side of the process air duct (or the process air unit), the tube bundle arrangement preferably contains an odd number of tube bundles (e.g. one or three or five).

In one embodiment of examples disclosed herein, the process air unit further comprises a first collecting box in the peripheral region of the process air duct, which connects the combustion chamber to all tubes of the tube bundle of the tube bundle arrangement facing the combustion chamber, and a second collecting box in the peripheral region of the process air duct, which connects all the tubes of the tube bundle of the tube bundle arrangement facing away from the combustion chamber to the flue gas discharge line. If the tube bundle arrangement comprises a single tube bundle, the two aforementioned collection boxes are each arranged in contact with this one tube bundle. If the tube bundle arrangement comprises several tube bundles, there is also a further collecting box in the peripheral region of the process air duct, which connects all tubes of a tube bundle to all tubes of an adjacent tube bundle of the tube bundle arrangement. Through the collection boxes, the flue gas is each diverted from the combustion chamber into the tubes of the tube bundle or from the tubes of one tube bundle into the tubes of the next tube bundle or from the tubes of the last tube bundle into the flue gas discharge line. The collection boxes are each arranged inside or outside or partially inside the process air duct. Furthermore, the collection boxes are preferably designed separately from each other in order to counteract thermal stresses.

Depending on the application, the inlet opening for taking in the process air to be heated is provided in one embodiment of examples disclosed herein at the first duct end in an end face of the process air duct, or in another embodiment of examples disclosed herein at the first duct end in a peripheral side of the process air duct. In the second mentioned embodiment, a baffle plate is preferably arranged on the tube bundle arrangement on the side facing the inlet opening, which, starting from the combustion chamber side, blocks at least some of the tubes (preferably the majority or all of the tubes) against overflow from the peripheral side of the process air duct. Such a baffle plate can ensure that the process air flows over the majority of the tube bundle arrangement transversely to the orientation of the tubes, even when flowing into the process air duct from the circumferential side, which ensures better heat transfer.

In a further embodiment of examples disclosed herein, the process air unit further comprises a filter for cleaning the process air, which is arranged downstream of the combustion chamber with respect to the process air flow direction. In this embodiment, a perforated plate is preferably also arranged between the combustion chamber and the filter for distributing the process air (as evenly as possible) to the filter. This measure ensures uniform use of the filter and a lower pressure loss. In another embodiment of examples disclosed herein without such a filter, the process air unit further comprises a perforated plate arranged downstream of the combustion chamber with respect to the process air flow direction for distributing the process air over the entire depth of the combustion chamber.

In a further embodiment of examples disclosed herein, the process air unit further comprises a fan for forcing the process air through the unit, which is arranged upstream of the tube bundle arrangement with respect to the process air flow direction. In this embodiment, the process air duct between the fan and the tube bundle arrangement preferably comprises a continuously expanded duct section and/or at least one air baffle for expanding the process air flow in order to flow over the tube bundle arrangement as evenly as possible. Instead of such a fan integrated in the process air unit, a fan can optionally also be arranged outside in front of the process air unit in the respective process air supply line.

Alternatively, the process air unit can further comprise a fan for drawing the process air through the unit, which is arranged downstream of the combustion chamber with respect to the process air flow direction. Instead of such a fan integrated in the process air unit, a fan can optionally also be arranged outside after the process air unit in the respective process air supply line.

In a further embodiment of examples disclosed herein, the process air unit further comprises at least one temperature detection apparatus for detecting a temperature of the process air upstream of the tube bundle arrangement and/or a temperature of the process air downstream of the combustion chamber. Instead of such a temperature detection device integrated in the process air unit, a corresponding temperature detection apparatus can optionally also be arranged in the respective process air supply line. The temperature detection apparatus comprises, for example, a temperature sensor such as a thermocouple, IR sensor, pyrometer, etc. for detecting a temperature of the process air. The temperature of the process air detected in this way upstream and/or downstream of the process air unit can be used to control the operation of the process air supply (in particular process air volume, burner output in the process air unit).

All of the above-described embodiments of the process air unit can be combined in almost any way within the scope of examples disclosed herein.

An object of examples disclosed herein also is a workpiece processing system comprising at least one process chamber for processing workpieces, and at least one process air supply line for supplying process air into the at least one process chamber, wherein a process air unit of examples disclosed herein described above is arranged in the at least one process air supply line.

The workpiece processing system is used, for example, for a painting process. The workpiece processing system is, for example, a continuous dryer, a continuous hardening system, a chamber dryer or a chamber hardening system for drying/linking/hardening painted and/or coated and/or glued workpieces such as car bodies or car body parts. However, examples disclosed herein is not limited to these special applications.

### BRIEF DESCRIPTION OF THE FIGURES

The above and other features and advantages of examples disclosed herein will be better understood from the following description of preferred, non-limiting embodiments with reference to the accompanying drawing. Therein show, mostly schematically:

FIG. 1 the structure of a workpiece processing system having process air units according to examples disclosed herein according to an exemplary embodiment of examples disclosed herein;

FIG. 2 a top view of the construction of the process air unit according to examples disclosed herein;

FIG. 3 a detailed top view of a process air unit according to a first embodiment of examples disclosed herein;

FIG. 4A a detailed top view of a process air unit according to a second embodiment of examples disclosed herein;

FIG. 4B a detailed side view of the process air unit of FIG. 4A;

FIG. 5 a detailed side view of a process air unit according to a further embodiment of examples disclosed herein;

FIG. 6 a detailed side view of a process air unit according to a further embodiment of examples disclosed herein; and

FIG. 7 a detailed top view of a process air unit according to a yet another embodiment of examples disclosed herein.

### DETAILED DESCRIPTION

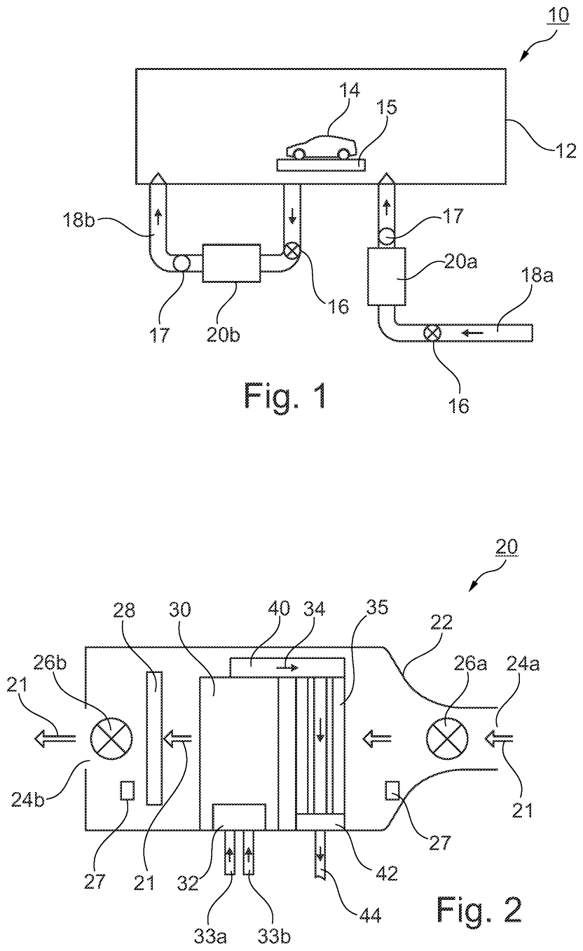

With reference to FIG. 1, an application example of the process air unit according to examples disclosed herein is first explained by way of example.

The workpiece processing system 10 shown in FIG. 1 is, for example, part of a painting system and has a process chamber 12, for example for drying/linking/hardening of painted and/or coated and/or glued workpieces 14 such as car bodies or car body parts. The workpiece 14 can be attached on a carrier (e.g. skid) 15, which transports the workpiece 14 through the process chamber 12. Depending on the application, the process chamber 12 can also comprise several zones (e.g. lock zones, heating zones, holding zones, etc.).

To the process chamber 12 or its zones is supplied a corresponding process air via at least one process air supply line 18. In the exemplary embodiment of FIG. 1, to the process chamber 12, fresh air is supplied via at least one fresh air line 18a and circulating air is supplied via at least one recirculation air line 18b. In the fresh air line 18a, there is arranged a process air unit 20a according to examples disclosed herein for heating the fresh air, and in the recirculation air line 18b, there is arranged a process air unit 20b according to examples disclosed herein for heating the circulating air.

As indicated in FIG. 1, in the process air supply lines 18, there can also be provided fans 16 for conveying the respective process air (e.g. upstream of the process air unit 20) and temperature detection apparatuses 17 for detecting the process air temperature (e.g. downstream of the process air unit 20). Alternatively, the fans and/or the temperature detection apparatuses can also be integrated into the respective process air units 20, as explained later in connection with exemplary embodiments of the process air unit 20.

Referring to FIG. 2, the basic design of the process air unit 20 according to examples disclosed herein, which can be used, for example, in the workpiece processing system 10 of FIG. 1 in the process air supply lines 18, is now explained in more detail.

The process air unit 20 has a process air duct 22, through which the respective process air 21 (e.g. fresh air or recirculating air) can flow. In the area of a first duct end (right in FIG. 2), the process air duct 22 has an inlet opening 24a for receiving the process air 21 to be heated from the process air supply line 18, and in the area of a second duct end opposite the first duct end (left in FIG. 2), the process air duct 22 has an outlet opening 24b for discharging the heated process air 21 into the process air supply line 18.

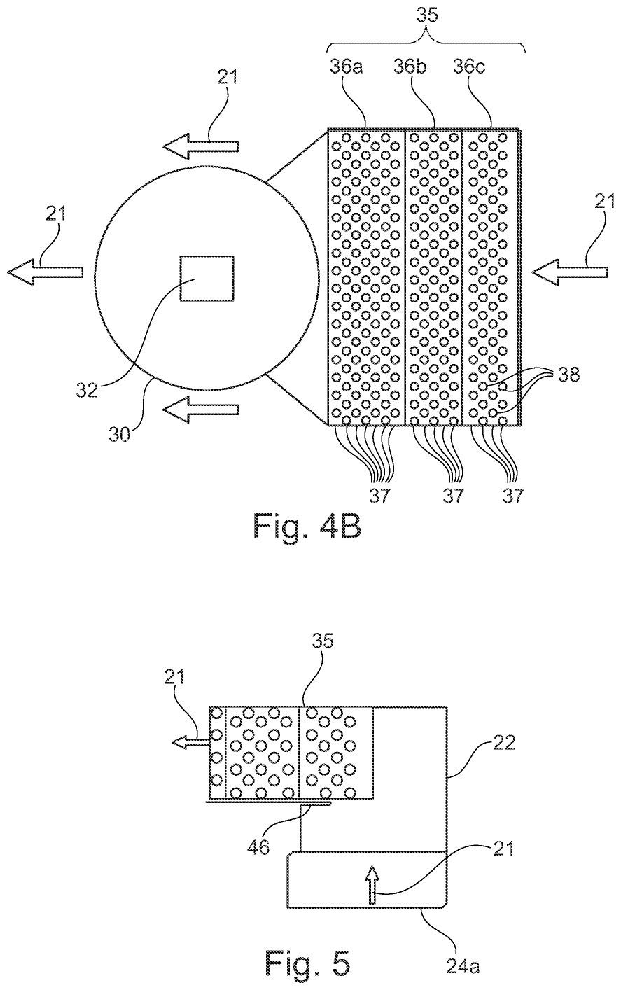

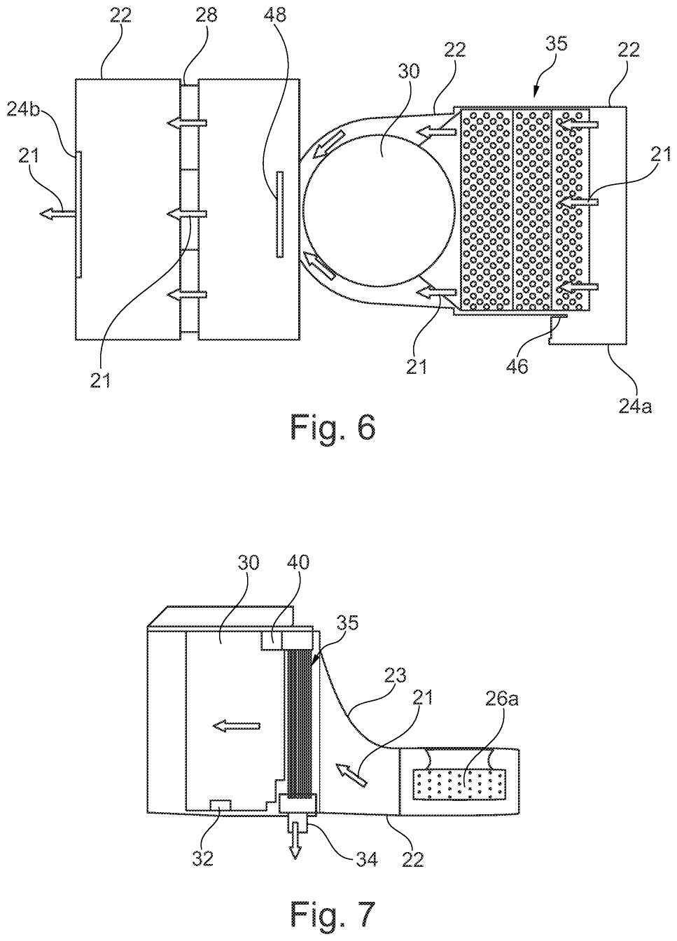

In the process air duct 22, there is arranged a combustion chamber 30 in the form of a normal gas combustion chamber, over which the process air 21 flows (i.e. does not flow in). The combustion chamber 30 has, for example, a round tubular shape (as can be seen, for example, in FIGS. 4B and 6), which is easier to manufacture compared to, for example, a pear-shaped combustion chamber, and is equipped with a burner 32 for burning combustion air. The burner 32 has, for example, a combustible supply 33a for introducing a liquid or preferably gaseous combustible (e.g. natural gas, hydrogen, etc.) into the combustion chamber 30, and a combustion air supply 33b for introducing combustion air (e.g. ambient air) into the combustion chamber 30. Depending on the application, the type of used combustible, the type of used combustion air and the desired temperature of the flue gas (=burned combustion air), the burner also contains an igniter for triggering the combustion process of the combustible and/or a heating apparatus (e.g. an electrical or electromagnetic heating apparatus or a switchable high-temperature heat source of another type) for supplying the combustion chamber 30 with heat energy so that the combustion air A to be burned, together with the combustible, immediately reaches a combustion temperature without the need for an additional ignition mechanism.

In the process air duct 22, there is also arranged a tube bundle arrangement 35, over which the process air 21 also flows. The combustion chamber 30 and the tube bundle arrangement 35 connected to it form a compact unit that can be inserted as a component into the process air unit 20. The tube bundle arrangement 35 comprises at least one tube bundle with several tubes and is connected to the combustion chamber 30 via a first collecting box 40, so that the flue gas 34 from the combustion chamber 30 flows through the tubes of the tube bundle arrangement 35. As illustrated in FIG. 2, the tube bundle arrangement 35 is constructed and arranged in the process air duct 22 such that the tubes are aligned transversely to the process air flow direction (right-left direction in FIG. 2), as shown in FIG. 2 (in this exemplary embodiment, for example essentially 90°). The tube bundle arrangement 35 is also connected to a flue gas discharge line 44 via a second collecting box 42 in order to discharge the flue gas 34, for example into the environment, via the flue gas discharge line after flowing through the tube bundle arrangement 35. In principle, the flue gas 34 could also be directed to a further heat exchanger after flowing through the process air duct 22, but this is rather disadvantageous because the flue gas retains very little residual heat due to the very efficient process air unit. In addition, after flowing through the process air duct 22, the flue gas 34 can optionally also be directed to the burner 32 for reuse as combustion air, although it should be noted that the flue gas contains, after the previous combustion, less or, in extreme cases, no combustible substances. In FIG. 2, the first and second collection boxes 40, 42 are exemplarily arranged inside the process air duct 22; alternatively, the first and second collection boxes 40, 42 can also be arranged only partially inside or completely outside the process air duct 22, since they primarily serve to redirect the flue gas 34, but not to transfer heat to the process air 21. As shown in FIG. 2, the combustion air supply 33b of the burner 32 and the flue gas discharge line 44 from the tube bundle arrangement 35 are both arranged on the same side (for example, the lower side) of the process air duct 22 or the process air unit 20.

As shown in FIG. 2, the tube bundle arrangement 35 according to examples disclosed herein is arranged upstream (right in FIG. 2) of the combustion chamber 30 in the process air duct 22 with respect to the process air flow direction, so that the process air 21 flowing in through the inlet opening 24a first flows over the tube bundle arrangement 35 and then flows over the combustion chamber 30 in order to have heat transferred from the flue gas. Due to this sequence of the tube bundle arrangement 35 to the combustion chamber 30 in the process air duct 22, the flue gas flow runs in a direction opposite to the process air flow through the process air duct 22, so that a great many or even all of the heat of the flue gas 34 can be transferred to the process air 21, whereby the process air unit 20 is very effective in terms of energy. In addition, the flows of the process air 21 run through the tube bundle arrangement 35 and then via the combustion chamber 30 essentially in a plane horizontally to the bottom side (bottom in FIG. 2) of the process air duct 22.

As illustrated in FIG. 2, in the process air unit 20, optionally there can also be integrated a fan 26a for pushing the process air 21 through the process air duct 22, which is arranged upstream of the tube bundle arrangement 35 with respect to the process air flow direction and thus in the vicinity of the inlet opening 24a, or a fan 26b for drawing the process air 21 through the process air duct 22, which is arranged downstream of the combustion chamber 30 with respect to the process air flow direction and thus in the vicinity of the outlet opening 24b. In this embodiment of the process air unit 20, fans 26 in the process air supply lines 18 can be dispensed with.

As an alternative or in addition to the fan 26a/26b, as illustrated in FIG. 2, a filter 28 for cleaning the process air 21, which is arranged downstream of the combustion chamber 30 with respect to the process air flow direction, and/or a temperature detection apparatus 27 for detecting a temperature of the process air 21 upstream of the tube bundle arrangement 35 and/or a temperature of the process air 21 downstream of the combustion chamber 30, can optionally also be integrated in the process air unit 20. The temperature detection apparatus 27 comprises, for example, one or more temperature sensors (e.g. thermocouple, IR sensor, pyrometer, etc.) for detecting the process air temperature and is connected, for example, to a control apparatus of the workpiece processing system 10, so that the operation of the process air supply (in particular process air quantity and burner output in the process air unit) into the process chamber 12 can also be controlled taking into account the detected process air temperature upstream and/or downstream of the process air unit.

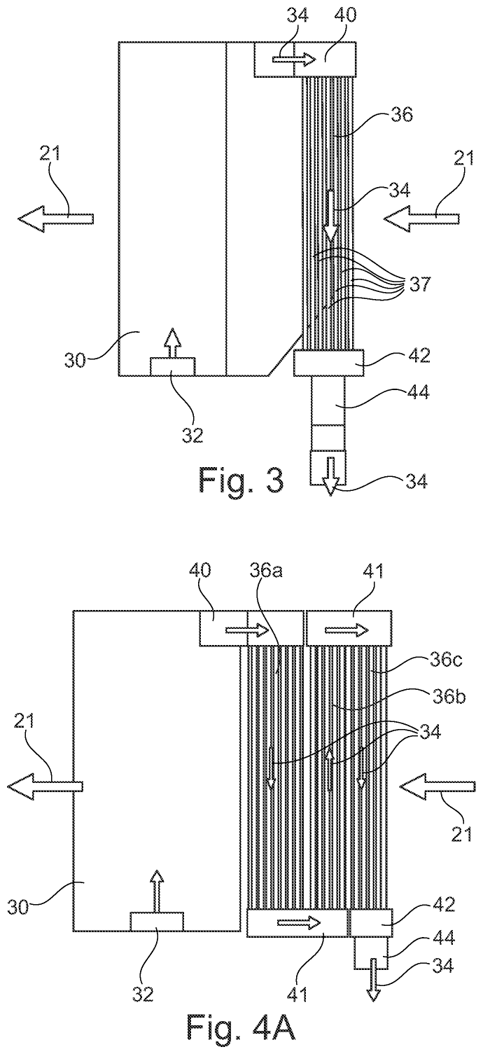

With reference to FIGS. 3 to 7, various embodiment variants/embodiments of the process air unit 20 according to examples disclosed herein are now explained in more detail. For the sake of simplicity, FIGS. 3 to 7 each show only a few special features/characteristics of the respective embodiment variants/forms, which can be present in the basic concept of the process air unit 20 described above with reference to FIG. 2, either individually or possibly in combination with others.

FIG. 3 shows an embodiment variant of the process air unit 20, in which the tube bundle arrangement 35 comprises a single tube bundle 36, which is arranged upstream of the combustion chamber 30 with respect to the process air flow direction. As illustrated more clearly in FIG. 3 than in FIG. 2, the tube bundle 36 contains several tube rows 37 which, in relation to the process air flow direction (right-left direction in FIG. 3), run behind one another and, for example, essentially parallel to one another. As indicated in FIG. 3, the tube bundle 36 can, for example, contain about seven tube rows 37. The several tube rows 37 of the tube bundle 36 each have several tubes which are positioned one below the other in view from above FIG. 3. The tubes of the different tube rows 37 can all or at least partially be displaced with respect to one another or arranged aligned with respect to one another. The plurality of tubes of the several tube rows 37 is connected to the combustion chamber 30 on the inlet side (top in FIG. 3) via the first collecting box 40, so that the flue gas 34 flows through all the tubes, and is connected to the flue gas discharge line 44 on the outlet side via the second collecting box 42, so that the flue gas 34 is output from all tubes.

FIGS. 4A and 4B show another embodiment variant of the process air unit 20, in which the tube bundle arrangement 35 comprises a plurality of tube bundles 36a, 36b, 36c (in this embodiment example, three), which are all arranged upstream of the combustion chamber 30 with respect to the process air flow direction, matching the arrangement of the combustion air supply 33b and the flue gas discharge line 44 on the same side of the process air duct 22. This embodiment variant, compared to the embodiment variant of FIG. 3 having a single tube bundle 36, reinforces the counterflow principle between the flue gas flow and the process air flow in the process air duct 22 and thus the heat transfer from the flue gas 34 to the process air 21 and consequently the energy efficiency of the process air unit 20.

The plurality of tube bundles 36a, 36b, 36c is arranged one behind the other with respect to the process air flow direction (right-left direction in FIGS. 4A and 4B), with the flue gas 34 passing through the various tube bundles 36n one after the other in a sequence counter to the process air flow direction (i.e. from left to right in FIGS. 4A and 4B). In addition, the flue gas 34 thereby flows through the tubes 38 of the successively arranged tube bundles 36a, 36b, 36c each in opposite directions transverse to the process air flow direction, as indicated by the flue gas flow arrows 34 in the center of the tube bundles 36n in FIG. 4A. Each tube bundle 36n has, analogous to the explanation above, several tube rows 37, each with several tubes 38. The tubes of the first tube bundle 36a closest to the combustion chamber 30 are connected to the combustion chamber 30 on the inlet side (top in FIG. 4A) via the first collecting box 40, and are connected to the tubes of the second tube bundle 36b on the outlet side (bottom in FIG. 4A) via the further collecting box 41. The tubes of the second tube bundle 36b are connected to the tubes of the first tube bundle 36a on the inlet side (bottom in FIG. 4A) via the further collecting box 41, and are connected to the tubes of the third tube bundle 36c on the outlet side (top in FIG. 4A) via a still further collecting box 41 at the furthest distance from the combustion chamber 30. The tubes of the third tube bundle 36c are connected on the inlet side (top in FIG. 4A) to the tubes of the second tube bundle 36b via the still further collecting box 41, and are connected on the outlet side (bottom in FIG. 4A) to the flue gas discharge line 44 via the second collecting box 42. In order to counteract thermal stresses, the collecting boxes 40, 41, 41, 42 are preferably designed separately from one another.

In order to ensure an optimum flow through the tubes 38 of the tube bundles 36n and to keep the pressure loss as low as possible, the individual tube bundles 36n of the tube bundle arrangement 35 preferably have different numbers of tube rows 37 and thus also of tubes 38. The first tube bundle 36a closest to the combustion chamber 30 preferably has the highest number of tube rows 37, since the temperature of the flue gas 34 and thus the operating volume flow are highest here. With each further tube bundle 36b, 36c, the number of tube rows 37 or tubes 38 decreases in the direction away from the combustion chamber 30, preferably by about 20% to 50% in each case, optionally by about 30% to 40%. In the exemplary embodiment of FIGS. 4A and 4B, the first tube bundle 36a has, for example, seven tube rows 37, the second tube bundle 36b has, for example, five tube rows 37, and the third tube bundle 36c has, for example, four tube rows 37. In another exemplary embodiment (not shown), the first tube bundle 36a has, for example, five tube rows 37, the second tube bundle 36b has, for example, four tube rows 37, and the third tube bundle 36c has, for example, three tube rows 37.

Depending on the application of the process air unit 20, for example, there may be different sizes and orientations of the parking positions. This can result in different inflow and outflow situations for the process air, which must be taken into account in the design of the process air unit.

FIG. 5 illustrates an embodiment of a process air unit 20 according to examples disclosed herein, in which the inlet opening 24a for taking in the process air 21 to be heated from the process air supply line 18 into the process air duct 22 is not provided at an end face of the process air duct 22, as shown in FIG. 2, but in a peripheral side of the process air duct 22 (e.g. at the bottom or top of the process air duct). Since the process air 21 is to flow over the tube bundles 36n of the tube bundle arrangement 35 transversely to the orientation of the tubes, in this embodiment, a baffle plate 46 is additionally arranged on the tube bundle arrangement 35. This baffle plate 46 is arranged on the side of the tube bundle arrangement 35 facing the inlet opening 24 (bottom in FIG. 5) and, starting from the combustion chamber side, blocks at least some of the tubes 38 or all of the tubes 38 against overflow from the peripheral side of the process air duct 22. Preferably, maximum of half of the tube rows of the individual tube bundle 36 or of the tube bundle 36c of the tube bundle arrangement 35 furthest away from the combustion chamber 30 should be able to be flowed through by the process air 21 from the peripheral side of the process air duct 22 through the baffle plate. Depending on the concept of the process air duct 22, the tube bundle arrangement 35 must be blocked by the baffle plate 46 from the combustion chamber 30 or only in the area of the most distant tube bundle 36c.

FIG. 6 illustrates an embodiment of the process air unit 20, in which a filter 28 for cleaning the heated process air 21 is integrated downstream of the combustion chamber 30. In this embodiment, a perforated plate 48 is preferably arranged between the combustion chamber 30 and the filter 28 in the process air duct 22. This perforated plate 48 can ensure a uniform flow of the filter 28 through the process air 21 and thus a uniform load of the filter 28 and a lower pressure loss.

In another embodiment of examples disclosed herein (not shown), such a perforated plate 48 can also be arranged downstream of the combustion chamber 30 without a filter 28. Even without a filter 28, this perforated plate 48 contributes that the process air (e.g. with a downstream fan 26b) flows evenly over the entire depth of the combustion chamber 30. As a result, the process air unit 20 is operated optimally in terms of its heat transfer efficiency, and the combustion chamber 30 is cooled evenly.

FIG. 7 illustrates an embodiment of the process air unit 20, in which a fan 26a for pushing the process air 21 through the process air duct 22 is integrated upstream of the tube bundle arrangement 35. In order to prevent, at such an arrangement of the fan 26a, the tube bundle arrangement 35 from being flowed unevenly shortly before the tube bundle arrangement 35, the process air duct 22 between the fan 26a and the tube bundle arrangement 35 is preferably designed with a continuously expanded duct section 23. The expansion can, for example, be in the form of a curved contour or composed of individual segments that discretize the curved shape. In addition, it may be useful to support the uniform flow to the tube bundle arrangement 35 by at least one air baffle in the process air duct 22.

In an alternative embodiment of examples disclosed herein (not shown), the continuously expanded duct section 23 of the process air duct 22 could also be completely replaced by air baffles in the process air duct 22. In this case, a linear or stepwise expansion of the process air duct could be used, and one or preferably more air baffles could be designed in this way and arranged in the process air duct 22 in such a way that at least the main part of the process air flow is continuously expanded/relaxed by the outer air baffles taking over the continuous expansion.

The scope of protection of examples disclosed herein is defined by the appended set of claims. The exemplary embodiments and application examples of the process air unit explained above, including variants thereof, serve in particular to provide a better understanding of examples disclosed herein, but are not intended to limit the scope of protection. The person skilled in the art will be able to recognize further embodiment variants within the scope of protection of examples disclosed herein, which are based, for example, on further combinations of features of the above exemplary embodiments, further combinations of one or more of the above exemplary embodiments (i.e. not only expressly mentioned combination examples), on individual omitted features of the above exemplary embodiments and/or on individual modified features of the above exemplary embodiment.

### REFERENCE NUMBER LIST

10 Workpiece processing system
12 Process chamber
14 Workpiece
15 Carrier
16 Fan (separate from 20)
17 Temperature detection apparatus (separate from 20)
18 Process air supply line (18a fresh air line/18b recirculating air line)
20 Process air unit (20a fresh air unit/20b recirculating air unit)
21 Process air
22 Process air duct
23 continuously expanded duct section
24a Inlet opening
24b Outlet opening
26 Fan (as part of 20)
   (26a upstream tube bundle arrangement/26b downstream combustion chamber)
27 Temperature detection apparatus (as part of 20)
28 Filter
30 Combustion chamber
32 Burner
33a Combustible supply
33b Combustion air supply
34 Flue gas
35 Tube bundle arrangement
36 Tube bundle
36n Tube bundle
37 Tube rows
38 Tubes
40 first collecting box between combustion chamber and tube bundle arrangement
41 further collecting box between two tube bundles
42 second collecting box at the end of the tube bundle arrangement
44 Flue gas discharge line
46 Baffle plate
48 perforated plate

1. A process air unit for heating a process air, comprising:
a process air duct through which a process air can flow and which comprises, in the region of a first duct end, an inlet opening for taking in a process air to be heated and, in the region of a second duct end opposite the first duct end, an outlet opening for discharging a heated process air;
a combustion chamber for burning a combustion air, which is arranged at least partially within the process air duct so that the combustion chamber is overflowed by the process air and thereby transfers heat to the process air; and
a tube bundle arrangement being connected to the combustion chamber and including at least one tube bundle having a plurality of tubes through which the flue gas from the combustion chamber can flow,
wherein the plurality of tubes of the at least one tube bundle is oriented transversely to the process air flow direction and is arranged at least partially within the process air duct so that they are overflowed by the process air and thereby transfer heat from the flue gas to the process air, and
wherein the tube bundle arrangement is arranged, with respect to the process air flow direction, upstream of the combustion chamber in the process air duct.

2. The process air unit according to claim 1, in which the tube bundle arrangement includes a plurality of tube bundles which are arranged one behind the other in the process air duct with respect to the process air flow direction, the flue gas passing through the different tube bundles one after the other in a sequence counter to the process air flow direction and thereby flowing through the tubes of the successively arranged tube bundles in opposite directions, each transverse to the process air flow direction.

3. The process air unit according to claim 2, in which the plurality of tube bundles of the tube bundle arrangement each comprise include a plurality of tube rows which extend one behind the other with respect to the process air flow direction, in each case in comparison between two adjacent ones of the plurality of tube bundles, the tube bundle closer to the combustion chamber having a larger number of tube rows than the tube bundle further away from the combustion chamber.

4. The process air unit according to claim 3, wherein the reduction in the number of tube rows between two adjacent tube bundles in the direction away from the combustion chamber each is 20% to 50%.

5. The process air unit according to claim 1, wherein:
a combustion air supply for introducing combustion air into the combustion chamber and a flue gas discharge line for discharging the flue gas after flowing through the tube bundle arrangement are arranged on the same side of the process air duct, and
the tube bundle arrangement contains an odd number of tube bundles.

6. The process air unit according to any of claims claim 1, further including:
a first collecting box in the peripheral region of the process air duct, which connects the combustion chamber to all tubes of the tube bundle of the tube bundle arrangement facing the combustion chamber:
a second collecting box in the peripheral region of the process air duct, which connects all the tubes of the tube bundle of the tube bundle arrangement facing away from the combustion chamber to the flue gas discharge line; and
if the tube bundle arrangement comprises includes several tube bundles, in each case a further collecting box in the peripheral region of the process air duct, which connects all tubes of a tube bundle to all tubes of an adjacent tube bundle of the tube bundle arrangement.

7. The process air unit according to claim 1, wherein the inlet opening for taking in the process air to be heated is provided at the first duct end in an end face of the process air duct.

8. The process air unit according to claim 1, wherein the inlet opening for receiving the process air to be heated is provided at the first duct end in a peripheral side of the process air duct, and a baffle plate is arranged on the tube bundle arrangement on the side facing the inlet opening, which, starting from the combustion chamber side, blocks at least a portion of the tubes against overflow from the peripheral side of the process air duct.

9. The process air unit according to claim 1, further including a filter being arranged downstream of the combustion chamber with respect to the process air flow direction, a perforated plate for distributing the process air to the filter being arranged between the combustion chamber and the filter.

10. The process air unit according to claim 1, further including a perforated plate, arranged downstream of the combustion chamber with respect to the process air flow direction, for distributing the process air over the entire depth of the combustion chamber.

11. The process air unit according to claim 1, further comprising including a fan which is arranged upstream of the tube bundle arrangement with respect to the process air flow direction, the process air duct between the fan and the tube bundle arrangement including a continuously expanded duct section.

12. The process air unit according to claim 1, further including a fan which is arranged upstream of the tube bundle arrangement with respect to the process air flow direction, the process air duct between the fan and the tube bundle arrangement comprising including at least one air baffle for expanding the process air flow.

13. The process air unit according to claim 1, further including a fan being arranged downstream of the combustion chamber with respect to the process air flow direction.

14. The process air unit according to claim 1, further including at least one temperature detection apparatus for detecting a temperature of the process air upstream of the tube bundle arrangement and/or a temperature of the process air downstream of the combustion chamber.

15. A workpiece processing system, comprising
at least one process chamber for processing workpieces; and
at least one process air supply line for supplying a process air into the at least one process chamber, wherein a process air unit for heating the process air according to claim 1 is arranged in the at least one process air supply line.

16. The process air unit according to claim 11, wherein the process air duct between the fan and the tube bundle arrangement includes at least one air baffle for expanding the process air flow.

17. The process air unit according to claim 12, wherein the process air duct between the fan and the tube bundle arrangement includes a continuously expanded duct section.
